(19) United States
(12) Patent Application Publication
(10) Pub. No.: US 2024/0372431 A1
(43) Pub. Date: Nov. 7, 2024

(54) ROTARY ELECTRIC MACHINE

(71) Applicant: DENSO CORPORATION, Kariya-city (JP)

(72) Inventors: Masaki AMAKAWA, Kariya-city (JP); Akira SAKAMOTO, Kariya-city (JP)

(73) Assignee: DENSO CORPORATION, Kariya-city (JP)

(21) Appl. No.: 18/778,318

(22) Filed: Jul. 19, 2024

Related U.S. Application Data
(63) Continuation of application No. PCT/JP2022/032954, filed on Sep. 1, 2022.

(30) Foreign Application Priority Data
Jan. 21, 2022 (JP) 2022-007827

(51) Int. Cl. H02K 7/00; H02K 5/04; H02K 7/18

(52) U.S. Cl. CPC H02K 7/003; H02K 5/04; H02K 7/1815

(57) ABSTRACT

A rotary electric machine includes a rotor directly joined to an output shaft of an internal-combustion engine. The rotary electric machine includes a first housing, a second housing that is mounted to the first housing and is fixed to a housing of the internal-combustion engine, a stator that is fixed to the first housing or the second housing, and a holding part that is provided to the second housing and holds the rotor so as to be rotatable with respect to the stator at a predetermined position. The rotor includes a joint part directly joined to the output shaft and rotates with respect to the stator at the predetermined position. The first housing and the second housing accommodate the stator and the rotor in a state in which the joint part is capable of being directly joined to the output shaft.

### CROSS-REFERENCE TO RELATED APPLICATION

The present application is based on and claims the benefit of priority from earlier Japanese Patent Application No. 2022-007827 filed on Jan. 21, 2022, the description of which is incorporated herein by reference.

### BACKGROUND

### Technical Field

The present disclosure relates to a rotary electric machine including a rotor directly joined to an output shaft of an internal-combustion engine.

### Related Art

A motor is disclosed in which a rotor is directly joined to a crankshaft of an internal-combustion engine by bolts and a stator is fixed to a cylinder block by bolts. When such a motor is mounted to the internal-combustion engine, the rotor is directly joined to the crankshaft, the stator is fixed to the cylinder block, and thereafter, a housing of the motor is fixed to the cylinder block.

### SUMMARY

An aspect of the present disclosure provides a rotary electric machine including a rotor directly joined to an output shaft of an internal-combustion engine, the rotary electric machine including: a first housing; a second housing that is mounted to the first housing and is fixed to a housing of the internal-combustion engine; a stator that is fixed to the first housing or the second housing; and a holding part that is provided to the second housing and holds the rotor so as to be rotatable with respect to the stator at a predetermined position. The rotor includes a joint part directly joined to the output shaft and rotates with respect to the stator at the predetermined position, and the first housing and the second housing accommodate the stator and the rotor in a state in which the joint part is capable of being directly joined to the output shaft.

### BRIEF DESCRIPTION OF THE DRAWINGS

In the accompanying drawings:

FIG. 1 is a schematic diagram illustrating an internal-combustion engine and an MG having an outer rotor structure;

FIG. 2 is a schematic diagram illustrating a gap between a joint part of a rotor and a holding component and a gap between a magnet of the rotor and a coil of a stator;

FIG. 3. is a schematic diagram illustrating a relationship between a taper of the joint part of the rotor and an end portion of a crankshaft;

FIG. 4. is a schematic diagram illustrating a manner of directly joining the joint part of the rotor to the end portion of the crankshaft;

FIG. 5. is a schematic diagram illustrating a manner of mounting the stator to a first housing and a manner of mounting the holding component to a second housing;

FIG. 6. is a schematic diagram illustrating a manner of mounting the rotor to the second housing;

FIG. 7. is a schematic diagram illustrating a manner of mounting the first housing and the second housing to each other;

FIG. 8 is a schematic diagram illustrating a state in which the MG is assembled;

FIG. 9 is a schematic diagram illustrating a manner of mounting the MG to an inspection machine and the internal-combustion engine;

FIG. 10 is a schematic diagram illustrating a modification of the MG having an outer rotor structure;

FIG. 11 is a the schematic diagram illustrating internal-combustion engine and an MG having an inner rotor structure; and

FIG. 12 is a schematic diagram illustrating a modification of the MG having an inner rotor structure.

### DETAILED DESCRIPTION OF THE PREFERRED EMBODIMENTS

A motor is disclosed in which a rotor is directly joined to a crankshaft of an internal-combustion engine by bolts and a stator is fixed to a cylinder block by bolts (refer to JP 2005-180261 A). When such a motor is mounted to the internal-combustion engine, the rotor is directly joined to the crankshaft, the stator is fixed to the cylinder block, and thereafter, a housing of the motor is fixed to the cylinder block.

When performance of the motor (rotary electric machine) disclosed in JP 2005-180261 A is inspected, the rotor is directly joined to an input shaft of an inspection machine, and the stator is fixed to a body or the like of the inspection machine, thereby rotating the rotor with respect to the stator at a predetermined position. When the motor that has been inspected is removed from the inspection machine and is thereafter mounted to the internal-combustion engine, the rotor and the stator are required to be separated from each other to thereafter mount them to the internal-combustion engine. Hence, performance of the motor may vary between a state in which the motor is mounted to the inspection machine and a state in which the motor is mounted to the internal-combustion engine, whereby the inspection result cannot be ensured.

In view of the above points, the present disclosure has an object of providing a rotary electric machine that includes a rotor directly joined to an output shaft of an internal-combustion engine and can be mounted to an inspection machine or the internal-combustion engine without separating the rotor and a stator from each other.

Hereinafter, an embodiment of an MG (Motor Generator) mounted to an internal-combustion engine installed in a hybrid vehicle will be described with reference to the drawings.

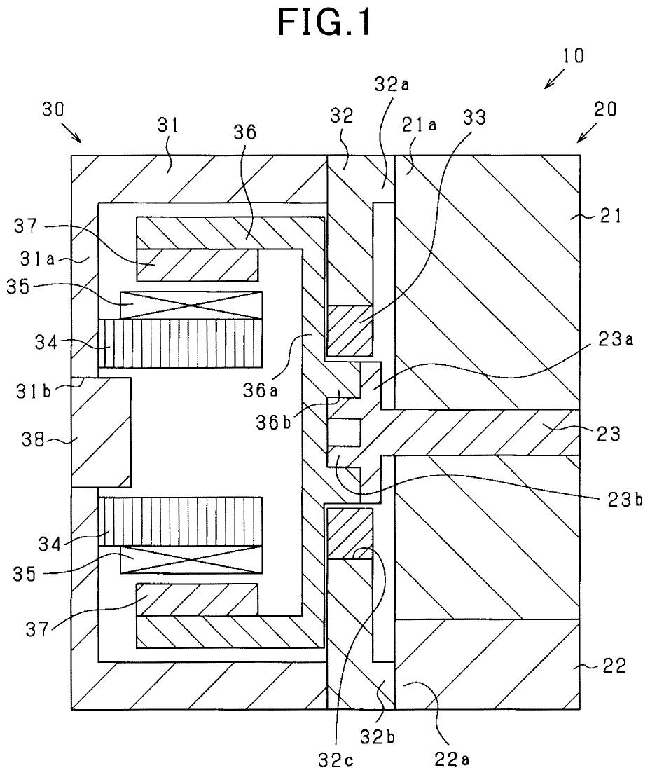

As illustrated in FIG. 1, a hybrid vehicle 10 includes an internal-combustion engine 20 and an MG 30. The hybrid vehicle 10 travels using the power of at least one of the internal-combustion engine 20 and the MG 30.

The internal-combustion engine 20 is, for example, a well-known reciprocating engine. The internal-combustion engine 20 includes a cylinder block 21, an oil pan 22, a crankshaft 23, and the like. The cylinder block 21 (housing) and the oil pan 22 (housing) are integrally joined by bolts, which are not shown, or the like. The cylinder block 21 accommodates a slidable piston (not shown). The crankshaft 23 (output shaft) is rotated based on reciprocating motion of the piston caused by burning of fuel.

An end of the crankshaft 23 is provided with a flange 23a and an engagement part 23b. The flange 23a has a disk shape. An outer diameter D1 of the flange 23a is larger than an outer diameter D0 of the crankshaft 23 (D0<D1). The engagement part 23b has a cylindrical shape and extends from the flange 23a in the axis line direction of the 10) crankshaft 23. An outer diameter D2 of the engagement part 23b is larger than the outer diameter D0 of the crankshaft 23 and is smaller than the outer diameter D1 of the flange 23a (D0<D2<D1). The outer diameter D2 of the engagement part 23b may be the outer diameter D0 of the crankshaft 23 or smaller (D2≤D0<D1).

The MG 30 (rotary electric machine) includes a first housing 31, a second housing 32, a holding component 33, a core 34, a coil 35, a rotor carrier 36, a magnet 37, a cover 38, and the like.

The first housing 31 has a bottomed cylindrical shape. The center of a bottom part 31a of the first housing 31 has a through hole 31b. The through hole 31b (insertion hole) is formed on an extension of the axis line of the crankshaft 23 in the bottom part 31a and faces the flange 23a and the engagement part 23b of the crankshaft 23. The cover 38 can be attached to or detached from the position corresponding to the through hole 31b of the bottom part 31a. The cover 38 closes the through hole 31b in a state in which the cover 38 is attached to the bottom part 31a to seal the first housing 31.

On the bottom part 31a, the core 34 is mounted (fixed) to the outer periphery of the through hole 31b. The core 34 cylindrically extends in the axis line direction of the crankshaft 23 from the bottom part 31a. The core 34 is formed by, for example, laminating a plurality of metal plates. Wiring is wound around an electrode part formed on the core 34, whereby the coil 35 is formed. Part of the coil 35 is disposed on the outer periphery of the core 34. The core 34 and the coil 35 configure a stator. That is, in the present embodiment, the coil 35 is located on the outermost periphery of the stator.

The second housing 32 has a disk shape. The center of the second housing 32 is provided with a through hole 32c. An outer edge of the second housing 32 is provided with a fixed part 32a fixed to a predetermined part 21a of the cylinder block 21 and a fixed part 32b fixed to a predetermined part 22a of the oil pan 22. The fixed part 32a has a shape corresponding to the shape of the predetermined part 21a of the cylinder block 21. The fixed part 32b has a shape corresponding to the shape of the predetermined part 22a of the oil pan 22. The holding component 33 is mounted to an inner peripheral edge of the second housing 32 (inner peripheral surface of the through hole 32c). The holding component 33 has an annular shape.

The first housing 31 and the second housing 32 are joined by bolts (fastening members), which are not shown. That is, the second housing 32 is mounted to the first housing 31. The fixed part 32a of the second housing 32 and the predetermined part 21a of the cylinder block 21 are joined by bolts, which are not shown. The fixed part 32b of the second housing 32 and the predetermined part 22a of the oil pan 22 are joined by bolts, which are not shown. That is, the second housing 32 is fixed to the cylinder block 21 and the oil pan 22 (internal-combustion engine 20). Hence, the first housing 31, the core 34, the coil 35, and the cover 38 are fixed to the cylinder block 21 and the oil pan 22 (internal-combustion engine 20) via the second housing 32.

The rotor carrier 36 has a bottomed cylindrical shape. The center of a bottom part 36a of the rotor carrier 36 is provided with a joint part 36b. The joint part 36b cylindrically extends in the axis line direction of the crankshaft 23 from the bottom part 36a. The inner diameter of the joint part 36b is substantially equal to the outer diameter of the engagement part 23b of the crankshaft 23 or slightly larger than the outer diameter of the engagement part 23b. The joint part 36b is fit to the outer periphery of the engagement part 23b. The flange 23a (crankshaft 23) and the joint part 36b (rotor carrier 36) are joined (directly joined) by bolts (fastening members), which are not shown. Hence, the rotor carrier 36 and the magnet 37 (rotor) rotate at a predetermined position with respect to the core 34 and the coil 35 (stator). In a state in which the flange 23a and the joint part 36b are joined, a predetermined gap is formed between the second housing 32 and the holding component 33, and the rotor carrier 36. The rotor carrier 36 and the magnet 37 configure a rotor.

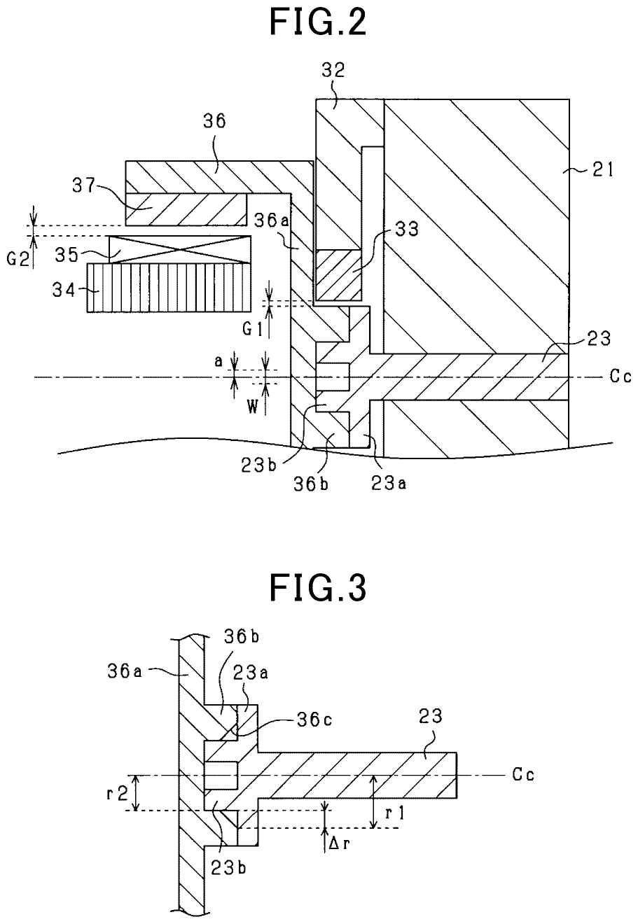

The outer diameter Df of the flange 23a is equal to the outer diameter Dc of the joint part 36b. The outer diameter Df of the flange 23a and the outer diameter Dc of the joint part 36b are slightly smaller than the inner diameter Dh of the holding component 33 (Df, Dc<Dn). That is, as illustrated in FIG. 2, a gap G1 is formed between the flange 23a and the joint part 36b (rotor), and the holding component 33.

The magnet 37 is disposed on the inner periphery of the rotor carrier 36. That is, in the rotor, the magnet 37 is located on the innermost periphery. As illustrated in FIG. 2, a gap G2 is formed between the coil 35 (stator) and the magnet 37 (rotor). The rotor is disposed outside the stator, that is, the MG 30 has a so-called outer rotor structure.

The through hole 31b of the bottom part 31a of the first housing 31 is formed to have a size in which a wrench (tool) for tightening the bolts joining the joint part 36b to the flange 23a can be inserted. That is, the first housing 31 and the second housing 32 accommodate the core 34, the coil 35 (stator), the rotor carrier 36, and the magnet 37 (rotor) in a state in which the joint part 36b is capable of being directly joined to the crankshaft 23. In a state in which the rotor carrier 36 is not joined to the crankshaft 23, the holding component 33 holds the rotor carrier 36 and the magnet 37 so as to be rotatable with respect to the core 34 and the coil 35 at the predetermined position. That is, even in the state in which the rotor carrier 36 is not joined to the crankshaft 23, the relationship between the core 34 and the coil 35, and the rotor carrier 36 and the magnet 37 is maintained by the holding component 33.

In the MG 30, driving force is generated by supplied electrical power to rotate the crankshaft 23, and the rotor carrier 36 and the magnet 37 are rotated by driving force of the crankshaft 23, thereby generating electrical power.

While the internal-combustion engine 20 is operating, the central axis Cc of the crankshaft 23 oscillates within a range W. At this time, the oscillation range in which the central axis Cc of the crankshaft 23 moves most is a. The gap G1 is set to be equal to or larger than the oscillation range a and equal to or smaller than the gap 2 (a≤G1≤G2). In a state in which the joint part 36b is fit to the outer periphery of the engagement part 23b, the central axis of the joint part 36b coincides with the central axis Cc of the crankshaft 23.

As illustrated in FIG. 3, a taper 36c is formed on an inner peripheral edge of an end of the joint part 36b of the rotor carrier 36. A width Δr of the taper 36c in the radial direction of the joint part 36b is set to the gap G1 or larger (G1≤Δr). That is, an aperture radius r1 of the taper 36c is set to be equal to or larger than a radius obtained by adding the gap G1 to a radius r2 of an outer edge of the engagement part 23b of the crankshaft 23 (r2+G1≤r1).

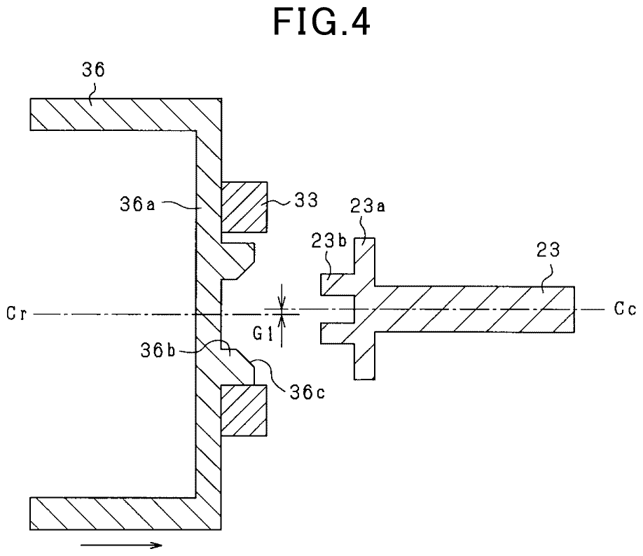

As illustrated in FIG. 4, when the central axis Cc of the crankshaft 23 coincides with the central axis of the holding component 33, the joint part 36b (rotor carrier 36) can move in the radial direction of the holding component 33 up to the length of the gap G1. Even in this case, the outer edge of the end of the engagement part 23b is within an aperture of the taper 36c. Hence, when the joint part 36b is joined (directly joined) to the flange 23a of the crankshaft 23, the taper 36c can guide the central axis Cr of the rotor carrier 36 so as to approach the central axis Cc of the crankshaft 23.

The MG 30 is previously assembled before being mounted to the internal-combustion engine 20. Hereinafter, a procedure of assembling the MG 30 will be described.

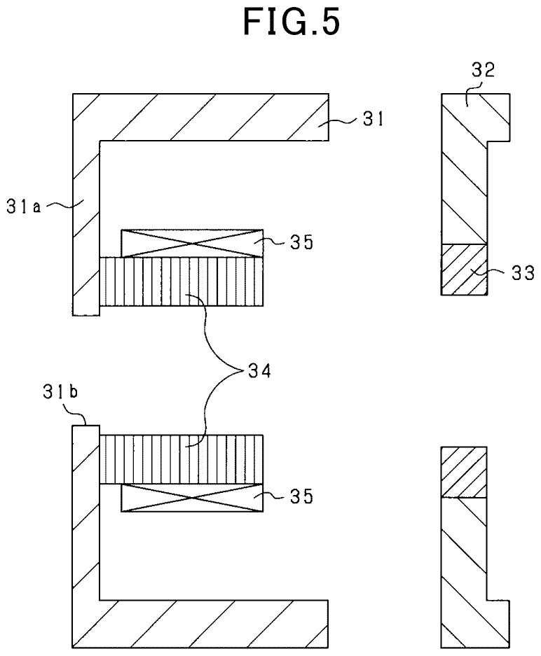

First, as illustrated in FIG. 5, the core 34 and the coil 35 are mounted to the first housing 31. The holding component 33 is mounted to the second housing 32.

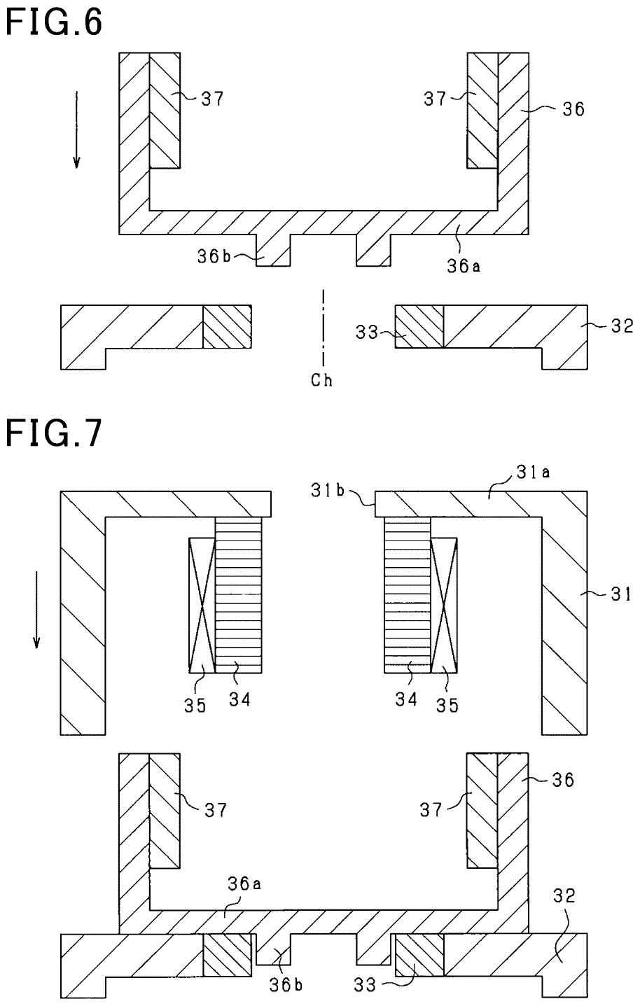

Next, as illustrated in FIG. 6, the second housing 32 and the holding component 33 are disposed so that the central axis Ch of the holding component 33 is directed in the vertical direction. Then, the joint part 36b of the rotor carrier 36 is inserted into the holding component 33 from the upper direction.

Next, as illustrated in FIG. 7, the core 34 and the coil 35 are inserted inside the rotor carrier 36 and the magnet 37.

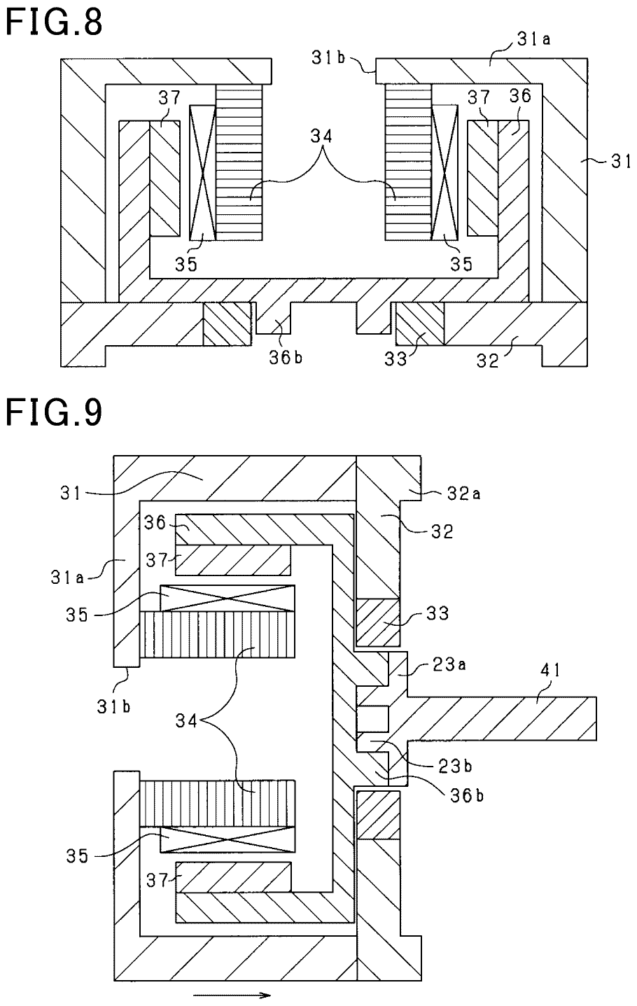

Next, as illustrated in FIG. 8, the first housing 31 and the second housing 32 are joined by bolts. Hence, the rotor carrier 36 and the magnet 37 are held so as to be rotatable with respect to the core 34 and the coil 35 at the predetermined position. In this state, the cover 38 may be attached to the first housing 31 or not be attached to the first housing 31.

If the crankshaft 23 of the internal-combustion engine 20 rotates in a state in which the rotor carrier 36 is directly joined to the crankshaft 23, the rotor carrier 36 oscillates due to an assembling error between the crankshaft 23 and the rotor carrier 36, oscillation of the crankshaft 23 in the internal-combustion engine 20, or the like. If a shaft bearing rotatably supporting the rotor carrier 36 is present, losses are caused by friction between the rotor carrier 36 and the shaft bearing due to the oscillation of the rotor carrier 36. Hence, conventionally, no shaft bearing is provided to the rotor carrier 36, but the rotor carrier 36 is supported only by the crankshaft 23.

Next, a procedure for mounting the MG 30 to an inspection machine will be described.

With reference to FIG. 9, a procedure for joining the rotor carrier 36 to an input shaft 41 of the inspection machine will be described. An end of the input shaft 41 is formed to a shape similar to that of the end of the crankshaft 23. The same parts as those of the crankshaft 23 are indicated by the same reference signs to omit redundant descriptions. Specifically, the MG 30 is caused to approach the inspection machine to fit the joint part 36b to the engagement part 23b of the input shaft 41. At this time, as illustrated in FIG. 4, the rotor carrier 36 is guided by the taper 36c so that the central axis Cr of the rotor carrier 36 approaches the central axis Cc pf the input shaft 41 (crankshaft 23). In addition, even if the joint part 36b (rotor carrier 36) moves with respect to the holding component 33, the coil 35 and the magnet 37 are prevented from contacting each other.

Next, in a state in which the cover 38 is detached from the first housing 31, a wrench is inserted into the first housing 31 through the through hole 31b. Then, bolts, which are not shown, are tightened by the wrench to join the joint part 36b to the flange 23a. Then, the fixed part 32b of the second housing 32 is fixed to a body or the like of the inspection machine. The cover 38 is attached to the first housing 31. Thereafter, driving or electrical power generation is performed by the MG 30 to inspect performance of the MG 30 by the inspection machine.

Next, a procedure of removing the MG 30 from the inspection machine and mounting the MG 30 to the internal-combustion engine 20 will be described.

First, the cover 38 is removed from the first housing 31. A wrench is inserted into the first housing 31 through the through hole 31b. Then, the bolts, which are not shown, are loosened by the wrench to separate the joint part 36b from the flange 23a. At this time, the rotor carrier 36 is held by the holding component 33. Next, the fixed part 32b of the second housing 32 is separated from the body or the like of the inspection machine. Hence, the MG is removed from the inspection machine.

Next, as in the case in which the MG 30 is mounted to the inspection machine, the MG 30 is mounted to the internal-combustion engine 20. The MG 30 is caused to approach the internal-combustion engine 20 to fit the joint part 36b to the engagement part 23b of the crankshaft 23. At this time, as illustrated in FIG. 4, the rotor carrier 36 is guided by the taper 36c so that the central axis Cr of the rotor carrier 36 approaches the central axis Cc of the crankshaft 23. In addition, even if the joint part 36b (rotor carrier 36) moves with respect to the holding component 33, the coil 35 and the magnet 37 are prevented from contacting each other. Next, in a state in which the cover 38 is detached from the first housing 31, a wrench is inserted into the first housing 31 through the through hole 31b. Then, the bolts, which are not shown, are tightened by the wrench to join the joint part 36b to the flange 23a. The fixed part 32a is fixed to the predetermined part 21a of the cylinder block 21 of the internal-combustion engine 20, and the fixed part 32b is fixed to the predetermined part 22a of the oil pan 22. The cover 38 is attached to the first housing 31.

The present embodiment described above has the following advantages.

The rotor carrier 36 of the MG 30 is directly joined to the crankshaft 23 of the internal-combustion engine 20 and rotates integrally with the crankshaft 23. The MG 30 includes the first housing 31, the second housing 32 mounted to the first housing 31 and fixed to the cylinder block 21 and the oil pan 22 of the internal-combustion engine 20, and the core 34 and the coil 35 fixed to the first housing 31. Hence, fixing the second housing 32 to the cylinder block 21 and the oil pan 22 of the internal-combustion engine 20 can fix the first housing 31, the core 34, and the coil 35 to the cylinder block 21 and the oil pan 22 of the internal-combustion engine 20 via the second housing 32.

The MG 30 includes the holding component 33 that is provided to the second housing 32 and holds the rotor carrier 36 and the magnet 37 so as to be rotatable with respect to the core 34 and the coil 35 at a predetermined position. Hence, mounting the second housing 32 to the first housing 31 can hold the rotor carrier 36 and the magnet 37 by the holding component 33 so as to be rotatable with respect to the core 34 and the coil 35 at the predetermined position even in a state in which the rotor carrier 36 is not directly joined to the crankshaft 23 of the internal-combustion engine 20. Hence, the first housing 31, the core 34 and the coil 35, the second housing 32, and the rotor carrier 36 and the magnet 37 can be previously assembled. When the MG 30 is assembled, after the core 34 and the coil 35, and the rotor carrier 36 and the magnet 37 are accommodated in the first housing 31 and the second housing 32, the second housing 32 can be mounted to the first 30 housing 31.

The rotor carrier 36 includes the joint part 36b directly joined to the crankshaft 23 and rotates with respect to the core 34 and the coil 35 at the predetermined position. Hence, directly joining the joint part 36b of the rotor carrier 36 to the crankshaft 23 of the internal-combustion engine 20 can dispose the rotor carrier 36 and the magnet 37 with respect to the core 34 and the coil 35 at the predetermined position and integrally rotate the rotor carrier 36 and the magnet 37, and the crankshaft 23. Hence, the crankshaft 23 of the internal-combustion engine 20 can be rotated by driving force of the MG 30, and the MG 30 can be caused to generate electrical power by driving force of the internal-combustion engine 20.

The first housing 31 and the second housing 32 accommodate the core 34 and the coil 35, and the rotor carrier 36 and the magnet 37 in a state in which the joint part 36b can be directly joined to the crankshaft 23. Hence, even in a state in which the first housing 31, the core 34 and the coil 35, the second housing 32, and the rotor carrier 36 and the magnet 37 are previously assembled, the joint part 36b of the rotor carrier 36 can be directly joined to the crankshaft 23 of the internal-combustion engine 20. Hence, the MG 30 including the rotor carrier 36 directly joined to the crankshaft 23 of the internal-combustion engine 20 can be mounted to the inspection machine and the internal-combustion engine 20 without separating the rotor carrier 36 and the magnet 37, and the core 34 and the coil 35 from each other. As a result, the inspection result can be ensured. In addition, when the MG 30 that has been inspected is removed from the inspection machine to mount the MG 30 to the internal-combustion engine 20, problems in separating the rotor carrier 36 and the magnet 37, and the core 34 and the coil 35 from each other and thereafter mounting them to the internal-combustion engine 20 can be avoided.

The gap G1 between the holding component 33 and the joint part 36b of the rotor carrier 36 is set to equal to or larger than an oscillation range (oscillation range a) of the rotor carrier 36 generated when the rotor carrier 36 directly joined to the crankshaft 23 rotates. Hence, even in a configuration including the holding component 33, which holds the rotor carrier 36 and the magnet 37 so as to be rotatable with respect to the core 34 and the coil 35 at the predetermined position, to previously assemble the first housing 31, the core 34 and the coil 35, the second housing 32, and the rotor carrier 36 and the magnet 37, losses are suppressed from being caused by friction between the joint part 36b of the rotor carrier 36 and the holding component 33.

If the magnet 37 and the coil 35 contact each other due to oscillation of the rotor carrier 36, the magnet 37 and the coil 35 may cause friction, which causes losses, or the magnet 37 and the coil 35 may be damaged. In this regard, the gap G1 between the holding component 33 and the joint part 36b of the rotor carrier 36 is set to be equal to or smaller than the gap G2 between the magnet 37 and the coil 35. Hence, even if the rotor carrier 36 oscillates, before the magnet 37 and the coil 35 contact each other, the joint part 36b of the rotor carrier 36 and the holding component 33 contact each other, whereby the magnet 37 and the coil 35 can be prevented from causing friction, which causes losses, and being damaged.

The first housing 31 is provided with the through hole 31b through which a wrench, which is used for directly joining the joint part 36b to the crankshaft 23, can be inserted. In addition, the cover 38 that closes the through hole 31b and is detachable is attached to the first housing 31. According to the configuration, detaching the cover 38 from the first housing 31 and inserting the wrench in the through hole 31b can directly join the joint part 36b of the rotor carrier 36 to the input shaft 41 of the inspection machine and directly join the joint part 36b of the rotor carrier 36 to the crankshaft 23 of the internal-combustion engine 20. Then, directly joining the joint part 36b of the rotor carrier 36 to the input shaft 41 of the inspection machine or the crankshaft 23 of the internal-combustion engine 20 and thereafter attaching the cover 38 to the first housing 31 can close the through hole 31b.

The joint part 36b has a cylindrical shape. On an inner peripheral edge of the joint part 36b, the taper 36c is formed which guides the rotor carrier 36 so that the central axis Cr of the rotor carrier 36 approaches the central axis Cc of the crankshaft 23 when the joint part 36b is directly joined to the crankshaft 23. Hence, when the joint part 36b is directly joined to the crankshaft 23, the central axis Cr of the rotor carrier 36 can easily coincide with the central axis Cc of the crankshaft 23.

The aperture radius r1 of the taper 36c is set to be equal to or larger than a radius obtained by adding the gap G1 between the holding component 33 and the joint part 36b of the rotor carrier 36 to the radius r2 of the outer edge of the engagement part 23b of the crankshaft 23 (r2+G1≤r1). Hence, in a state in which the holding component 33 is positioned at the crankshaft 23 of the internal-combustion engine 20, even if the rotor carrier 36 moves with respect to the holding component 33, the outer edge of the engagement part 23b of the crankshaft 23 can be accommodated within a range of an opening of the taper 36c. Hence, the rotor carrier 36 can be easily guided by the taper 36c so that the central axis Cr of the rotor carrier 36 approaches the central axis Cc of the crankshaft 23, and assembly of the rotor carrier 36 to the crankshaft 23 can be improved.

The second housing 32 includes the fixed parts 32a, 32b fixed to the predetermined parts 21a, 22a of the respective cylinder block 21 and oil pan 22 of the internal-combustion engine 20. The fixed parts 32a, 32b have shapes respectively corresponding to those of the predetermined parts 21a, 22a. According to the configuration, fixing the fixed parts 32a, 32b of the second housing 32 having shapes respectively corresponding to the shapes of the predetermined parts 21a, 22a to the predetermined parts 21a, 22a of the respective cylinder block 21 and oil pan 22 of the internal-combustion engine 20 can mount the MG 30 to the cylinder block 21 and oil pan 22 of the internal-combustion engine 20. Furthermore, even when the shapes of the predetermined parts 21a, 22a of the respective cylinder block 21 and oil pan 22 are changed, this can be addressed by changing the second housing 32, whereby the first housing 31 can have a common configuration regardless of the shapes of the predetermined parts 21a, 22a of the respective cylinder block 21 and oil pan 22.

The above embodiment can be modified as below. The same parts as those of the above embodiment are indicated by the same reference signs to omit redundant descriptions.

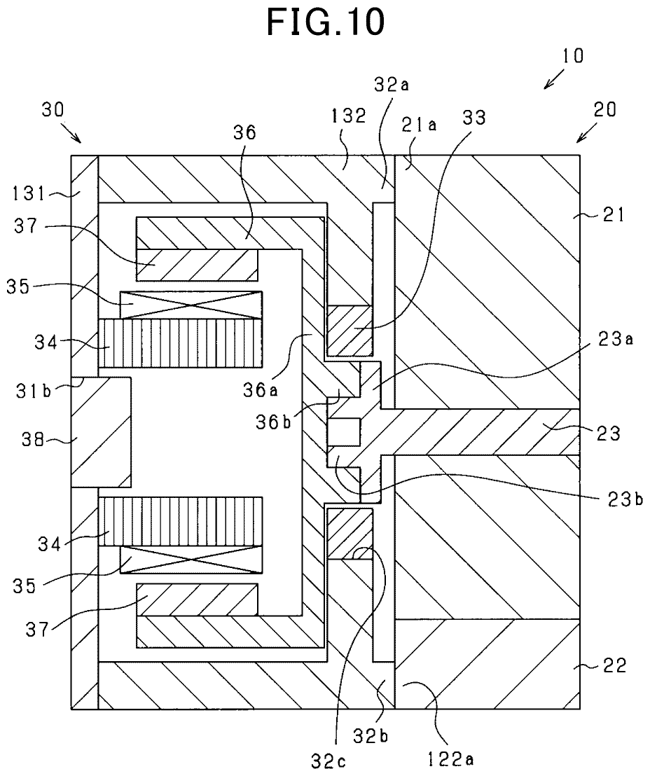

As illustrated in FIG. 10, a first housing 131 may have a disk shape, and a second housing 132 may have a cylindrical shape. Also according to this configuration, effects similar to those of the above embodiment can be provided.

If the first housing 31 is not required to be sealed, the cover 38 can be omitted. In this case, the through hole 31b can be configured by a plurality of through holes having a minimum size in which a wrench (tool) can be inserted.

The flange 23a of the crankshaft 23 and the joint part 36b of the rotor carrier 36 may be joined by screws. In this case, the through hole 31b may have a size in which a screwdriver (tool) can be inserted. Fastening members (fixing members) other than bolts and screws and a tool corresponding to the fastening members may be employed. In addition, after performance of the MG 30 is inspected, welding (joining) the rotor carrier 36 (rotor) to the crankshaft 23 can also directly join the rotor carrier 36 to the crankshaft 23. In this case, a welding tool (tool) may be inserted through the through hole 31b to perform the welding.

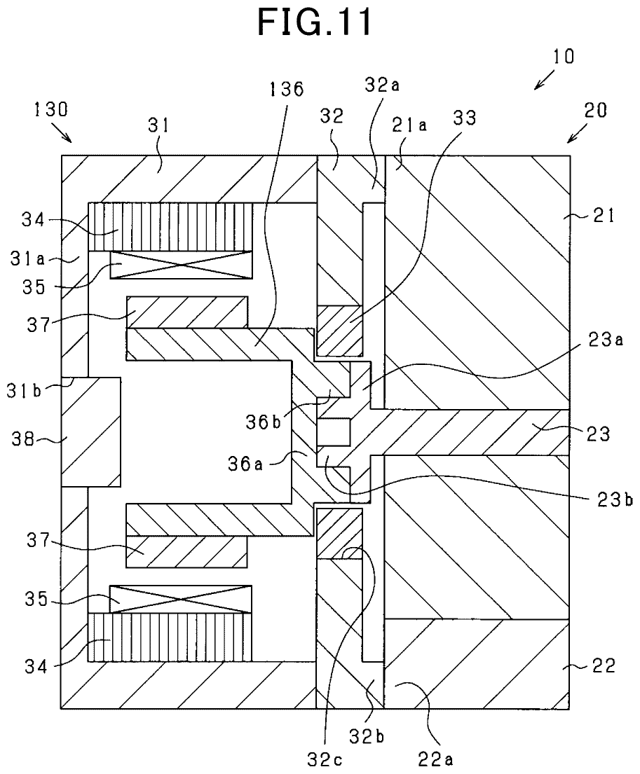

As illustrated in FIG. 11, an MG 130 having an inner rotor structure may be employed. The core 34 and the coil 35 (stator) may be mounted (fixed) to the first housing 31. Also in this case, the gap G1 between the joint part 36b (rotor) and the holding component 33 is set to be equal to or larger than the oscillation range a of the crankshaft 23 (oscillation range of a rotor carrier 136) and equal to or smaller than the gap G2 between the coil 35 (stator) and the magnet 37 (rotor) (a≤G1≤G2). Also according to this configuration, effects similar to those of the above embodiment can be provided.

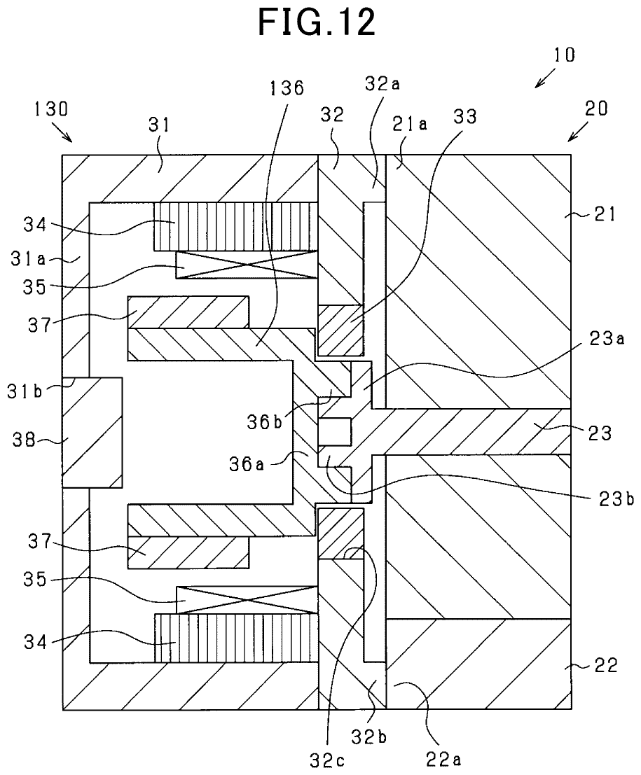

As illustrated in FIG. 12, in the MG 130 having an inner rotor structure, the core 34 and the coil 35 (stator) may be mounted to the second housing 32. Also in this case, the gap G1 between the joint part 36b (rotor) and the holding component 33 is set to be equal to or larger than the oscillation range a of the crankshaft 23 (oscillation range of the rotor carrier 136) and equal to or smaller than the gap G2 between the coil 35 (stator) and the magnet 37 (rotor) (a≤G1≤G2). Also according to this configuration, effects similar to those of the above embodiment can be provided.

A rotor in which the magnet 37 is embedded in the rotor carrier 36, 136 or a rotor not including the magnet 37 may be employed. In addition, a stator in which the core 34 is closer to the magnet 37 (rotor) than the coil 35 is may be employed. Even in these cases, the gap G1 between the rotor and the holding component 33 may be set to be equal to or larger than the oscillation range a of the crankshaft 23 (oscillation range of the rotor carrier 36, 136) and equal to or smaller than the gap G2 between the stator and the rotor (a≤G1≤G2).

The gap G1 between the joint part 36b (rotor) and the holding component 33 may be slightly smaller than the oscillation range a of the crankshaft 23 (oscillation range of the rotor carrier 36, 136). Also in this case, losses caused by friction between the joint part 36b (rotor) and the holding component 33 are small. In addition, as the holding component 33, bearings that can form the gap G1 may be employed.

The taper 36c of the joint part 36b of the rotor carrier 36, 136 may be omitted.

The second housing 32 may include a holding part corresponding to the holding component 33. That is, part of the second housing 32 may implement functions of the holding component 33.

Instead of the MG 30, 130, a motor or a generator may be employed.

The internal-combustion engine 20 may be not only a reciprocating engine but also a rotary engine including a housing and an output shaft. The above embodiment and modifications may be applied to an REEV (Range Extended Electric Vehicle) that does not directly use torque of an engine as power but is used only for electric power generation. In addition, the above embodiment and modifications may be applied to an agricultural machine, a constructional machine, an electric aircraft, a tracked vehicle, and the like including the internal-combustion engine 20 and a rotary electric machine.

The modifications may be combined.

The present disclosure has so far been described based on embodiments. However, the present disclosure should not be construed as being limited to these embodiments or the structures. The present disclosure should encompass various modifications, and modifications within the range of equivalence. In addition, various combinations and modes, as well as other combinations and modes, including those which include one or more additional elements, or those which include fewer elements should be construed as being within the scope and spirit of the present disclosure.

Hereinafter, characteristic configurations extracted from the embodiments and modifications described above will be described.

### Configuration 1

A rotary electric machine (30, 130) including a rotor (36, 37, 136) directly joined to an output shaft (23) of an internal-combustion engine (20), the rotary electric machine including:
a first housing (31, 131);
a second housing (32, 132) that is mounted to the first housing and is fixed to a housing of the internal-combustion engine;
a stator (34, 35) that is fixed to the first housing or the second housing; and
a holding part (33) that is provided to the second housing and holds the rotor so as to be rotatable with respect to the stator at a predetermined position, wherein
the rotor includes a joint part (36b) directly joined to the output shaft and rotates with respect to the stator at the predetermined position, and
the first housing and the second housing accommodate the stator and the rotor in a state in which the joint part is capable of being directly joined to the output shaft.

### Configuration 2

The rotary electric machine according to configuration 1, wherein
a gap (G1) between the holding part and the rotor is set to equal to or larger than an oscillation range (a) of the rotor generated when the rotor directly joined to the output shaft rotates.

### Configuration 3

The rotary electric machine according to configuration 1 or 2, wherein
the gap between the holding part and the rotor is set to equal to or smaller than a gap (G2) between the rotor and the stator.

### Configuration 4

The rotary electric machine according to configuration 1, wherein
the gap between the holding part and the rotor is set to equal to or larger than the oscillation range of the rotor generated when the rotor directly joined to the output shaft rotates and equal to or smaller than the gap between the rotor and the stator.

### Configuration 5

The rotary electric machine according to any one of configurations 1 to 4, wherein
the first housing has a through hole (31b) through which a tool, which is used when the joint part is directly joined to the output shaft, is insertable, and a cover (38), which closes the through hole and is detachable, is attached to the first housing.

### Configuration 6

The rotary electric machine according to any one of configurations 1 to 4, wherein
the first housing has a through hole through which a tool, which is used when the joint part is directly joined to the output shaft, is insertable.

### Configuration 7

The rotary electric machine according to any one of configurations 1 to 6, wherein
the joint part has a cylindrical shape, and an inner peripheral edge of the joint part has a taper (36c) that guides the rotor so that a central axis (Cr) of the rotor approaches a central axis (Cc) of the output shaft when the joint part is directly joined to the output shaft, and
an aperture radius (r1) of the taper is set to be equal to or larger than a radius obtained by adding a gap between the holding part and the rotor to a radius (r2) of an outer edge of an end of the output shaft.

### Configuration 8

The rotary electric machine according to any one of configurations 1 to 7, wherein
the second housing includes a fixed part fixed to a predetermined part of the housing of the internal-combustion engine, and the fixed part has a shape corresponding to a shape of the predetermined part.

### Configuration 9

The rotary electric machine according to any one of configurations 1 to 8, wherein
the rotor (36, 37) is disposed outside the stator, and
the stator is fixed to the first housing.

### Configuration 10

The rotary electric machine according to any one of configurations 1 to 8, wherein
the rotor (136, 37) is disposed inside the stator, and
the stator is fixed to the first housing or the second housing.

A first aspect of the present disclosure provides a rotary electric machine (30, 130) including a rotor (36, 37, 136) directly joined to an output shaft (23) of an internal-combustion engine (20), the rotary electric machine including: a first housing (31, 131); a second housing (32, 132) that is mounted to the first housing and is fixed to a housing of the internal-combustion engine; a stator (34, 35) that is fixed to the first housing or the second housing; and a holding part (33) that is provided to the second housing and holds the rotor so as to be rotatable with respect to the stator at a predetermined position. The rotor includes a joint part (36b) directly joined to the output shaft and rotates with respect to the stator at the predetermined position, and the first housing and the second housing accommodate the stator and the rotor in a state in which the joint part is capable of being directly joined to the output shaft.

According to the above configuration, the rotor of the rotary electric machine is directly joined to the output shaft of the internal-combustion engine and rotates integrally with the output shaft. The rotary electric machine includes the first housing, the second housing mounted to the first housing and fixed to the housing of the internal-combustion engine, and the rotor fixed to the first housing or the second housing. Hence, fixing the second housing to the housing of the internal-combustion engine can fix the first housing and the stator to the housing of the internal-combustion engine via the second housing.

The rotary electric machine includes the holding part that is provided to the second housing and holds the rotor so as to be rotatable with respect to the stator at a predetermined position. Hence, mounting the second housing to the first housing can hold the rotor by the holding part so as to be rotatable with respect to the stator at the predetermined position even in a state in which the rotor is not directly joined to the output shaft of the internal-combustion engine. Hence, the first housing, the stator, the second housing, and the rotor can be previously assembled. When the rotary electric machine is assembled, after the stator and the rotor are accommodated in the first housing and the second housing, the second housing can be mounted to the first housing.

The rotor includes the joint part directly joined to the output shaft and rotates with respect to the rotor at the predetermined position. Hence, directly joining the joint part of the rotor to the output shaft of the internal-combustion engine can dispose the rotor with respect to the rotor at the predetermined position and integrally rotate the rotor and the output shaft. Hence, the output shaft of the internal-combustion engine can be rotated by driving force of the rotary electric machine, and the rotary electric machine can be caused to generate electrical power by driving force of the internal-combustion engine.

Furthermore, the first housing and the second housing accommodate the stator and the rotor in a state in which the joint part can be directly joined to the output shaft. Hence, even in a state in which the first housing, the stator, the second housing, and the rotor are previously assembled, the joint part of the rotor can be directly joined to the output shaft of the internal-combustion engine. Hence, the rotary electric machine including the rotor directly joined to the output shaft of the internal-combustion engine can be mounted to the inspection machine or the internal-combustion engine without separating the rotor and the stator from each other. As a result, the inspection result can be ensured. In addition, when the rotary electric machine that has been inspected is removed from the inspection machine to mount the rotary electric machine to the internal-combustion engine, a trouble to separate the rotor and the stator from each other and thereafter mount them to the internal-combustion engine can be omitted.

If the output shaft of the internal-combustion engine rotates in a state in which the rotor is directly joined to the output shaft, the rotor oscillates due to an assembling error between the output shaft and the rotor, oscillation of the output shaft in the internal-combustion engine, or the like. If a shaft bearing rotatably supporting the rotor is present, losses are caused by friction between the rotor and the shaft bearing 15 due to the oscillation of the rotor. Hence, conventionally, no shaft bearing is provided to the rotor.

In this regard, in a second aspect, a gap (G1) between the holding part and the rotor is set to equal to or larger than an oscillation range (a) of the rotor generated when the rotor directly joined to the output shaft rotates. Hence, even in a configuration including the holding part, which holds the rotor so as to be rotatable with respect to the stator at the predetermined position, to previously assemble the first housing, the stator, the second housing, and the rotor, losses are suppressed from being caused by friction between the rotor and the holding part.

If the rotor and the stator contact each other due to oscillation of the rotor, the rotor and the stator may cause friction, which causes losses, or the rotor and the stator may be damaged.

In this regard, in a third aspect, the gap between the holding part and the rotor is set to equal to or smaller than a gap (G2) between the rotor and the stator. Hence, even if the rotor oscillates, before the rotor and the stator contact each other, the rotor and the holding part contact each other, whereby the rotor and the stator can be prevented from causing friction, which causes losses, and being damaged.

In a fourth aspect, the gap between the holding part and the rotor is set to equal to or larger than the oscillation range of the rotor generated when the rotor directly joined to the output shaft rotates and equal to or smaller than the gap between the rotor and the stator.

According to the above configuration, effects similar to those of the second aspect and the third aspect can be provided.

In a fifth aspect, the first housing has a through hole (31b) through which a tool, which is used when the joint part is directly joined to the output shaft, is insertable, and a cover (38), which closes the through hole and is detachable, is attached to the first housing. According to the configuration, detaching the cover from the first housing and inserting the tool in the through hole can directly join the joint part of the rotor to the input shaft of the inspection machine and directly join the joint part of the rotor to the output shaft of the internal-combustion engine. Then, directly joining the joint part of the rotor to the input shaft of the inspection machine or the output shaft of the internal-combustion engine and thereafter attaching the cover to the first housing can close the through hole.

In a sixth aspect, the first housing has a through hole through which a tool, which is used when the joint part is directly joined to the output shaft, is insertable.

According to the above configuration, the cover can be omitted from the fifth aspect.

In a seventh aspect, the joint part has a cylindrical shape, and an inner peripheral edge of the joint part has a taper (36c) that guides the rotor so that a central axis (Cr) of the rotor approaches a central axis (Cc) of the output shaft when the joint part is directly joined to the output shaft, and an aperture radius (r1) of the taper is set to be equal to or larger than a radius obtained by adding a gap between the holding part and the rotor to a radius (r2) of an outer edge of an end of the output shaft.

According to the above configuration, the joint part has a cylindrical shape. On an inner peripheral edge of the joint part, the taper is formed which guides the rotor so that the central axis of the rotor approaches the central axis of the output shaft when the joint part is directly joined to the output shaft. Hence, when the joint part is directly joined to the output shaft, the central axis of the rotor can easily coincide with the central axis of the output shaft.

Furthermore, the aperture radius of the taper is set to be equal to or larger than a radius obtained by adding the gap between the holding part and the rotor to the radius of the outer edge of the end of the output shaft. Hence, in a state in which the holding part is positioned at the output shaft of the internal-combustion engine, even if the rotor moves with respect to the holding part, the outer edge of the end of the output shaft can be accommodated within a range of an opening of the taper. Hence, the rotor can be easily guided by the taper so that the central axis of the rotor approaches the central axis of the output shaft, and assembly of the rotor to the output shaft can be improved.

In an eighth aspect, the second housing includes a fixed part fixed to a predetermined part of the housing of the internal-combustion engine, and the fixed part has a shape corresponding to a shape of the predetermined part. According to the configuration, fixing the fixed parts of the second housing having shapes respectively corresponding to the shapes of the predetermined parts to the predetermined parts of the internal-combustion engine can mount the rotary electric machine to the housing of the internal-combustion engine. Furthermore, even when the shapes of the predetermined parts of the housing are changed, it can be addressed by changing the second housing, whereby the first housing can have the common configuration regardless of the shapes of the predetermined parts of the housing.

Specifically, in a ninth aspect, the rotor (36, 37) is disposed outside the stator, and the stator is fixed to the first housing. That is, a so-called outer rotor structure may be employed.

In addition, specifically, in a tenth aspect, the rotor (136, 37) is disposed inside the stator, and the stator is fixed to the first housing or the second housing. That is, a so-called inner rotor structure may be employed.

What is claimed is:

1. A rotary electric machine including a rotor directly joined to an output shaft of an internal-combustion engine, the rotary electric machine comprising:
a first housing;
a second housing that is mounted to the first housing and is fixed to a housing of the internal-combustion engine;
a stator that is fixed to the first housing or the second housing; and
a holding part that is provided to the second housing and holds the rotor so as to be rotatable with respect to the stator at a predetermined position, wherein
the rotor includes a joint part directly joined to the output shaft and rotates with respect to the stator at the predetermined position, and
the first housing and the second housing accommodate the stator and the rotor in a state in which the joint part is capable of being directly joined to the output shaft.

2. The rotary electric machine according to claim 1, wherein
a gap between the holding part and the rotor is set to equal to or larger than an oscillation range of the rotor generated when the rotor directly joined to the output shaft rotates.

3. The rotary electric machine according to claim 1, wherein
the gap between the holding part and the rotor is set to equal to or smaller than a gap between the rotor and the stator.

4. The rotary electric machine according to claim 1, wherein
the gap between the holding part and the rotor is set to equal to or larger than the oscillation range of the rotor generated when the rotor directly joined to the output shaft rotates and equal to or smaller than the gap between the rotor and the stator.

5. The rotary electric machine according to claim 1, wherein
the first housing has a through hole through which a tool, which is used when the joint part is directly joined to the output shaft, is insertable, and a cover, which closes the through hole and is detachable, is attached to the first housing.

6. The rotary electric machine according to claim 1, wherein
the first housing has a through hole through which a tool, which is used when the joint part is directly joined to the output shaft, is insertable.

7. The rotary electric machine according to claim 1, wherein
the joint part has a cylindrical shape, and an inner peripheral edge of the joint part has a taper that guides the rotor so that a central axis of the rotor approaches a central axis of the output shaft when the joint part is directly joined to the output shaft, and
an aperture radius of the taper is set to be equal to or larger than a radius obtained by adding a gap between the holding part and the rotor to a radius of an outer edge of an end of the output shaft.

8. The rotary electric machine according to claim 1, wherein
the second housing includes a fixed part fixed to a predetermined part of the housing of the internal-combustion engine, and the fixed part has a shape corresponding to a shape of the predetermined part.

9. The rotary electric machine according to claim 1, wherein
the rotor is disposed outside the stator, and
the stator is fixed to the first housing.

10. The rotary electric machine according to claim 1, wherein
the rotor is disposed inside the stator, and
the stator is fixed to the first housing or the second housing.
